(19) United States
(12) Patent Application Publication
(10) Pub. No.: US 2005/0090198 A1
(43) Pub. Date: Apr. 28, 2005

(54) Method to extend millimeter wave satellite communication (75-98 GHz) and 3-10 micron laser links to wide areas in the temperate zone

(76) Inventor: Paul F. Christopher, Lessburg, VA (US)

Correspondence Address: Paul F. Christopher, 312 Loudoun Street, SW, Leesburg, VA, 20175, US

(21) Appl. No.: 10/964,543

(22) Filed: Oct. 14, 2004

Related U.S. Application Data
(60) Provisional application No. 60/514,843, filed on Oct. 27, 2003.

(51) Int. Cl. H04B 7/185

(52) U.S. Cl. 455/12.1; 455/13.3

(57) ABSTRACT

The inventor shows new, lower atmospheric attenuation in the 75-98 GHz satellite band. This lower attenuation occurs at 90% link availability. This opens up the 75-98 GHz satellite band immediately for users who can accept 90% link availability. The inventor then uses cloud autocorrelation functions to show compact switched arrays of ground sites to support availability requirements greater than 97%. This method applies to the new 75-98 GHz satellite band and the 3 micron-10 micron laser bands. These compact arrays would allow conventional availability to be attained in these previously unreliable and unattainable bands, at important temperate zone sites as New York City and Rome. The inventor shows compact square arrays with length of a side as typically less than 20 km, and discusses equilateral triangular arrays with similar lengths. Dual sites are shown to usually require larger separation distances.

### RELATED APPLICATION

The present invention claims priority to a U.S. provisional application 60/514,843 filed on Oct. 27, 2003 Title: Method to Extend Millimeter Wave Satellite Communication (75-98 GHz) to Wide Areas in the Temperate Zone by the present inventor, which is hereby incorporated by reference (Reference 1 in Detailed Description). The present invention is also directly related to two prior patent filings, U.S. application Ser. No. 09/986,057 Filed Nov. 7 2001 Title: “Broadband Communication For Satellite-Ground or Air-Ground Links,” by the present inventor, and U.S. application Ser. No. 10/079,411, Filed: Feb. 22, 2002, Title: A System and Method for Satellite Communications, Inventors: John E. Draim, and the present inventor. These two prior filings are hereby incorporated by reference (Reference 2 and Reference 3, respectively).

### FIELD OF THE INVENTION

The present invention relates to a satellite communications system utilizing orbiting communications satellites and reception/transmission stations. The system utilizes high frequency bands in the 75-98 GHz region and the 3-10 micron laser region for communication with the reception/transmission stations arrayed to reduce reception outage and/or transmission outage.

### BACKGROUND

Traditional communication satellites orbit above the Earth's equator at the same rotational velocity as the Earth's rotational velocity. This results in an apparently stationary orbit, with the satellite referred to as a Geosynchronous Orbit (GSO). GSOs orbit at a distance of 42164.4 km from the center of the Earth.

Earlier patent filings (1, 2, 3) have also shown other important orbits, with other important advantages. These other orbits include inclined, elliptical orbits such as Molniya orbits and other key elliptical orbits which offer important advantages for communication in the Earth Temperate Zones. The earlier filings have also emphasized advantageous groupings of satellites, where combinations of GSOs and Molniya can be more effective as a group than any single kind alone.

Satellite communication analysts have concentrated on rain attenuation as an essential guide for frequency selection since the mid '60s. This has resulted in an emphasis on frequencies less than 6 GHz for many systems until 1984. The advantages of higher frequencies, such as higher gain at constant aperture, were unfortunately de-emphasized or even outright ignored. Fortunately, the pressing need for satellite spectrum pushed satellite designers to the 12-14 GHz Ku band area in 1990. Signal attenuation was found to be fortunately low, and designers were happily surprised to find systems performance remarkably better than the prior favorites at 6 GHz. In a similar context the inventor has proposed (1, 2, 3) to press much further to higher frequencies. The present filing will allow even better use of the 75-98 GHz and 3-10 micron laser region in high traffic regions such as New York City than (2, 3) by allowing for lower single link availability, and then improving the site availability to acceptable standards with the aid of fixed compact arrays of receivers. These arrays are much more compact than diversity spacing presently used for satellite communication because these new arrays use cloud autocorrelation functions.

### BRIEF DESCRIPTION OF THE INVENTION

An earlier filing (2) showed that satellite attenuation in the 30-49 GHz and 75-98 GHz bands can be more attractive for use in satellite communication than had been perceived earlier. Atmospheric attenuation was chosen at the 99% (non-rainy) availability level: this availability level required key ground locations such as New York City and Rome to be confined to frequencies less than 45 GHz for acceptable communications performance.

Here, we start with the Inventor's new derivation (4) that gives lower attenuation at the 90% and 80% availability levels. These new, low attenuations may be immediately acceptable for simple single links at 75-98 GHz in useful prime areas such as New York City and Rome.

The method goes much further, however, to describe a collection of diverse sites that will conveniently allow availability greater than 97% for the 75-98 GHz region. It would also apply to an infrared laser region with wavelength as 10 microns.

The “switched” diversity method uses the greatest of several signals as the useful output at any time. The availability of two independent sites would be:
Availability2=1−(1−Availability1)²

More generally, however, the two ground sites are not independent, and the correlation coefficient is not zero. They would have a general correlation coefficient rho (□). In that case, the availability for the two sites would be
Availability2=1−(1−Availability1)^{(2-□)}

This method uses the correlation coefficient of Boldyrev and Tulopov described in (5). This correlation coefficient has not been previously recognized to be significant for satellite communications, and it is used here for the new method and results.

### BRIEF DESCRIPTION OF THE DRAWINGS

FIG. 1-1 represents the inventor's new results for zenith attenuation at Rome as a function of probability PR.

FIG. 1-2 represents zenith attenuation at Rome v. frequency for a family of probability PR.

FIG. 1-3 shows the inventor's zenith attenuation results v. Longitude, Latitude at 90 GHz, with PR=0.01

FIG. 1-4 shows zenith attenuation at 90 GHz for a 90% non rainy condition: PR=0.1

FIG. 2-1 shows an inclined elliptic Molniya orbit, at 1 Hour Intervals.

Eq. 5-1 is the elevation Probability Density Function (pdf) for 3 phased Molniya satellites paired with 2 GSOs.

FIG. 2-2 shows the MolniyaGEO Elevation PDF v. Latitude, Elevation.

FIG. 3-1 shows signal loss v. F at Guam, Rome, NY, Oslo for a Molniya Geo System; with Rome and NY as nearly identical.

FIG. 3-2 shows Net Loss at constant aperture at Guam, Rome, NY, Oslo for a MolniyaGEO System for a wide range of frequencies.

FIG. 3-3 shows lower Loss v. F at Guam, Rome, Oslo with 90% Probability.

FIG. 3-4 shows lower Net Loss at Guam, Rome, Oslo for 90% Probability, with a MolniyaGEO System; P=90%

FIG. 3-5 shows optimum frequency topography with 90% Non Rainy Conditions.

FIG. 3-6 shows optimum frequency contours at 90% Non Rainy Conditions.

Eq. 3-2 shows integrated gaseous attenuation.

Eq. 3-3 Mathematica listing shows the inventor's attenuation equation as a function of Longitude, Latitude, Frequency (GHz), and probability (PR).

FIG. 5-1 shows Furuhama's Rain Correlation Function for Typhoon (top) and for July.

FIG. 5-2 shows the correlation function for all rain.

Eq. 5-1 lists the mathematical function for the correlation.

Eq. 5-2 lists Pierce's mathematical function for two correlated sites.

FIG. 5-1 shows Pierce's correlated exponential pdf.

Eq. 5-3 is the joint exceedance probability for the bivariate correlation function.

FIG. 5-2 shows the exceedance probability PR v. (AR/B), Correlation r.

FIG. 5-3 shows PR contours v. AR/B, r.

Eq. 5-4 shows the inventor's new equation for least attenuation for two switched sites.

FIG. 5-4 shows Normalized attenuation (AR/B) v. Log 10[Exceedance Prob], Correlation r.

FIG. 6-1 shows severe attenuation at NY, with exceedance probability pr=0.001

FIG. 6-2 shows reduced attenuation with switched diversity at NY.

FIG. 6-3 shows Net Loss v. frequency at NY, with site separation=8 km.

Eq. 6-1 lists Boldyrev's could autocorrelation function.

FIG. 6-4 shows the Soviet cloud autocorrelation function v. distance (km).

FIG. 7-1 shows a method to separate ground sites to give Dual Diversity, with switching to use the site with higher signal level.

FIG. 7-2 plots availability with dual sites vs. separation distance (km).

FIG. 7-3 shows availability for 3 equilateral sites vs. distance on each side (km).

FIG. 7-4 Availability for Quad Diversity vs. distance (km) on Each Side of Square.

FIG. 7-5 shows availability for Quad Diversity v. single link availability, distance on side.

FIG. 7-6 shows 10 micron IR link availability, with Quad Diversity v. length on side.

FIG. 7-7 shows 10 micron link availability with Triangular Array v. length of side.

FIG. 7-8 shows a typical configuration with Quad Diversity, with switching to use the site with highest signal level.

### DETAILED DESCRIPTION OF THE INVENTION

Method to Extend Millimeter Wave Satellite Communication (75-98 GHz) and 10 Micron Laser Links to Wide Areas in the Temperate Zone

Overview of this Section

The inventor extends a four dimensional satellite attenuation model to five dimensions, with the aid of an exponential probability variable. Millimeter wave satellite communication in the 75-98 GHz region is indicated to be attractive for most of the Temperate Zone, with a 90% non rainy condition. The second part discusses diversity and advantages for high availability.

1. Background

Gaseous attenuation for satellite links was derived [4] in the early '80s [Appendix] by integrating terrestrial attenuation equations over the changing pressure as a function of altitude. These new results were conceptual and practical improvements over terrestrial attenuation equations which are often used for satellite communication. The integrated equations were intended to start a global attenuation model, but unknown cloud attenuation and water vapor attenuation stymied attempts at global attenuation models in the early '80s.

Fortunately, the Foundation Ugo Bordone used the invaluable Italsat results to derive global attenuation results at several important frequencies [5]. The integrated gaseous attenuation equations [6] could then be reexamined to see if they could yield a global attenuation model over a wide range of frequencies. The zenith attenuation maps shown by Barbaliscia, Boumis, and Martellucci for 49.5 and 22.2 GHz 99% non rainy conditions were especially valuable: They could be compared to the integrated gaseous attenuation for a satellite link. The excess attenuation implied by the FUB studies was then attributed to water vapor and clouds [7]. The attenuation maps at 49.5 and 22.2 GHz were then solved simultaneously for cloud and water vapor attenuation at 22.2 GHz. The simultaneous solution was done at all points on the map. This allowed a functional description (actually, two functional descriptions: One long, and one short shown in the appendix of the '99 paper) of zenith attenuation as a function of Longitude, Latitude, and frequency for frequencies in the 6 to 100 GHz range. This 4 dimensional attenuation function was very helpful directly and indirectly. It indicated that satellites with high elevation angles [7,8] would offer promising performance for frequencies greater than 40 GHz in much of the Temperate Zone. Frequencies greater than 80 GHz were indicated to be attractive for Latitudes greater than 50N.

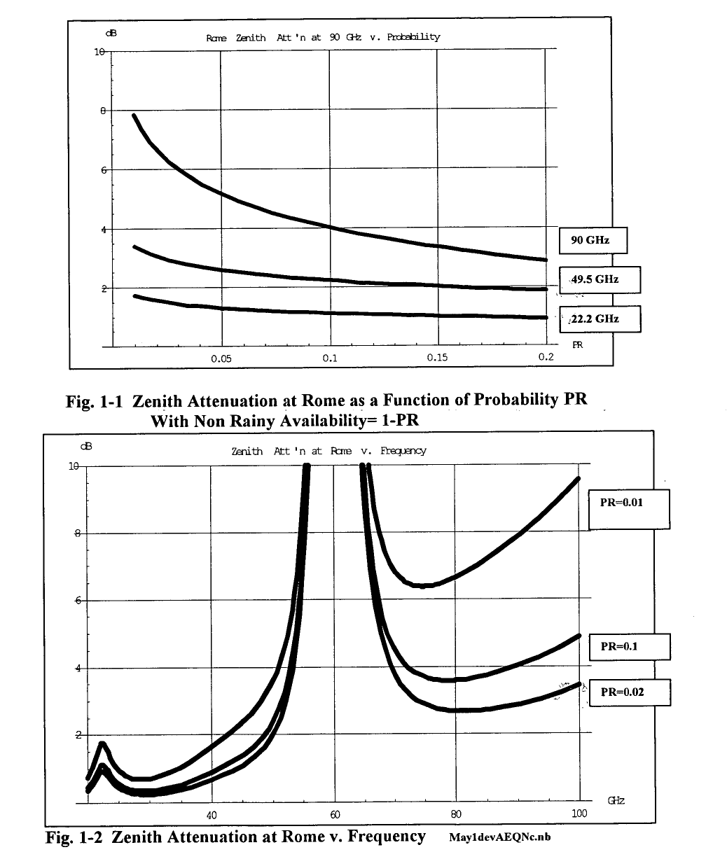

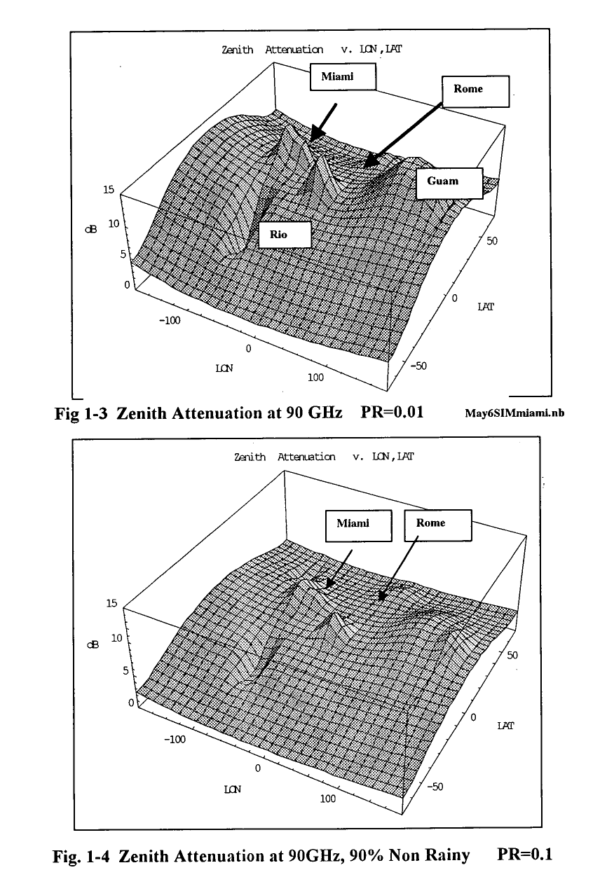

The question of communication in less severe attenuation remained unresolved. Here, we examine an earlier Italsat analysis [9] and find that cloud and vapor attenuation follow well behaved exponential probability density functions (pdf). We derive a new global equation for attenuation: It raises the prior four dimensional equation to five, with the new probability variable (Appendix). That is, zenith attenuation will be expressed as a function of Longitude, Latitude, frequency, and probability. The new probability dimension might be examined locally by choosing a single location, as Rome in FIG. 1-1, where the bottom two curves (22, 49.5 GHz) may be compared directly with the FUB 1997 paper [9]. The top curve was derived.

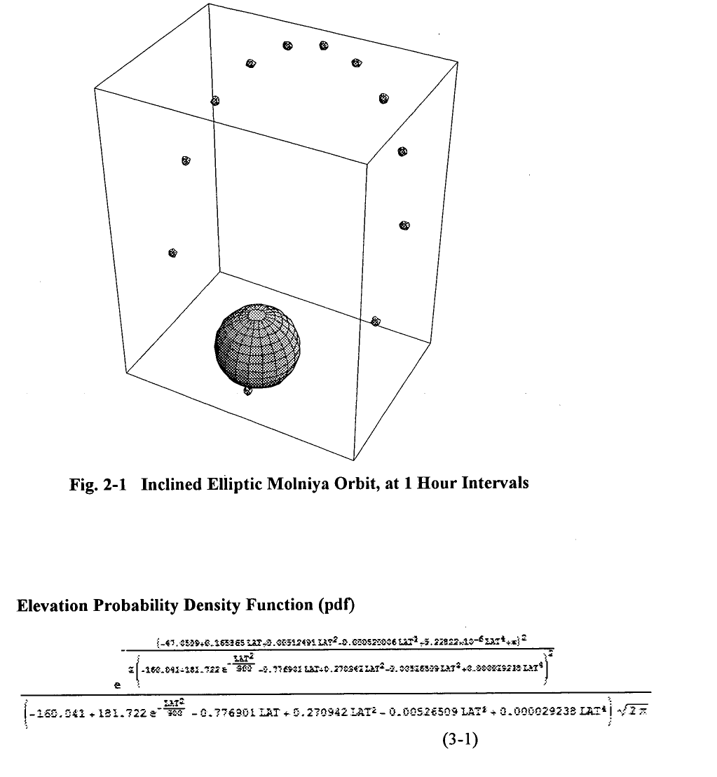

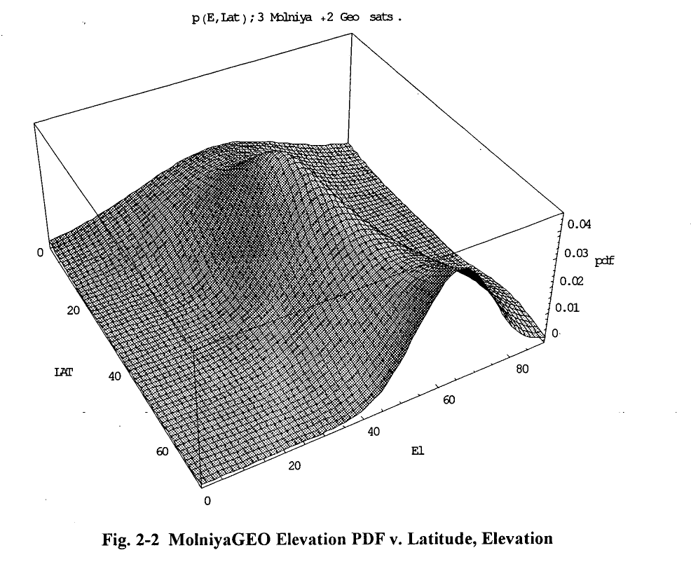

The results can be seen across a range of frequencies as FIG. 1-2.

The five dimensional zenith attenuation function can also be seen as global maps for constant probability PR. It can be shown as FIG. 1-3 for PR=0.01 at 90 GHz, as it was in Sicily [6]. FIG. 1-4 may be compared at PR=0.1, as the 90% non rainy condition.

2. Attenuation for High Elevation Satellite Systems

The zenith attenuation of the prior section must be weighted by the atmospheric path length, or closely as Cosecant[elevation angle]. Zenith attenuation near 10 dB at New York for 90 GHz in FIG. 1-3 would be doubled to 20 dB for a 30 degree elevation to a satellite. Some geosynchronous satellites do indeed present 30 degree elevation to New York, so 20 dB might be foreseeable for a 90 GHz New York link to a GEO. This attenuation would be debilitating for a millimeter wave system, and we ask if there could be any relief from high elevation systems. The Molniya satellite was conceived by the Soviets as an outstanding high elevation satellite in the mid-1960s. It may be seen at one hour intervals of its 12 hour orbit in FIG. 2-1.

The Cleveland paper [7] discussed a system of 3 phased Molniya satellites to deliver high elevation angles in the Northern Temperate zone. It added two geostationary satellites for complementary coverage at low latitudes, for a five satellite system called a MolniyaGEO system, for lack of a better descriptor. The elevation angles are consistently high: An elevation probability density function may be shown as FIG. 2-2.

The elevation pdf as a function of Latitude (LAT) is shown as Eq. 3-1.

Average elevation is close to 60 degrees at 60N, and more importantly high elevation as 50 degrees is seen at New York City near 40 North. The average cosecant[elevation] at each latitude can be found, and multiplied by zenith attenuation to find representatively higher satellite attenuation. The satellite attenuation south of 20N would be clearly higher than the zenith attenuation: 60% extra attenuation [dB] would be expected on the best MolniyaGEO path at 20N. The most useful parts of the Temperate Zone would include regions between 30N to 60N. We note that NY City and Rome are near 40N.

3. Optimum Frequencies

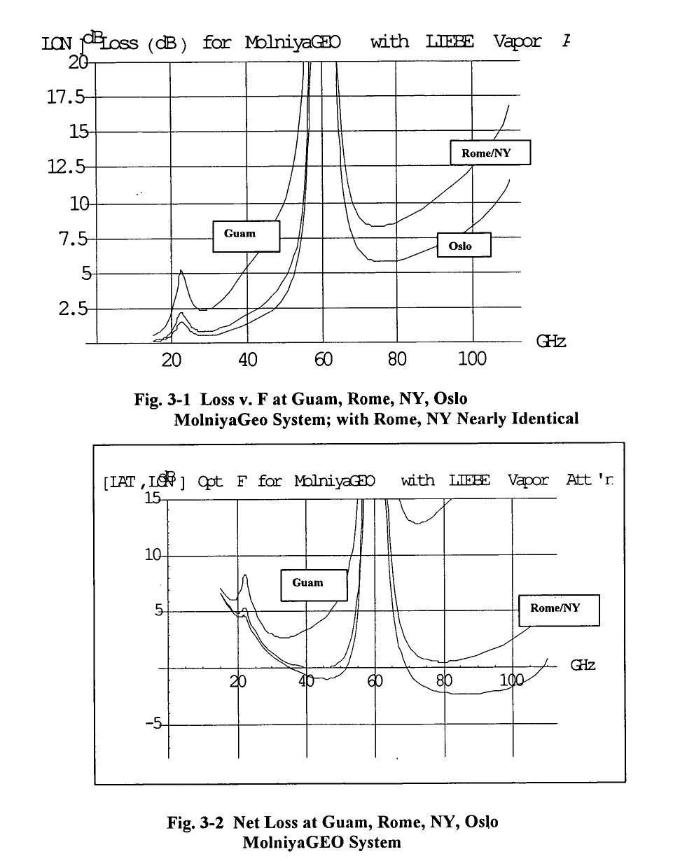

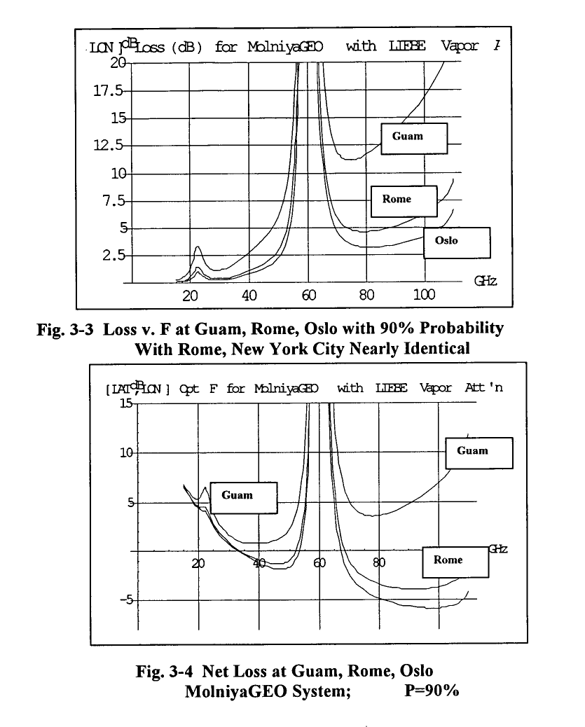

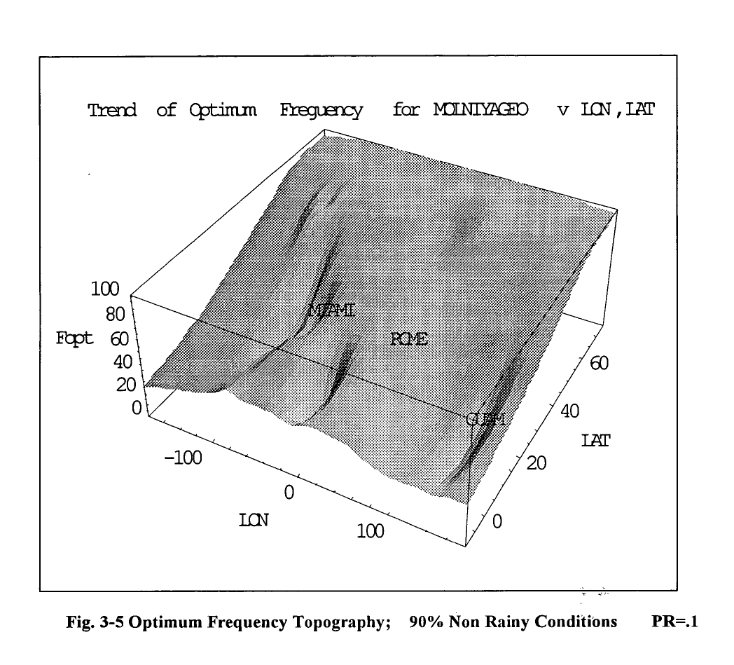

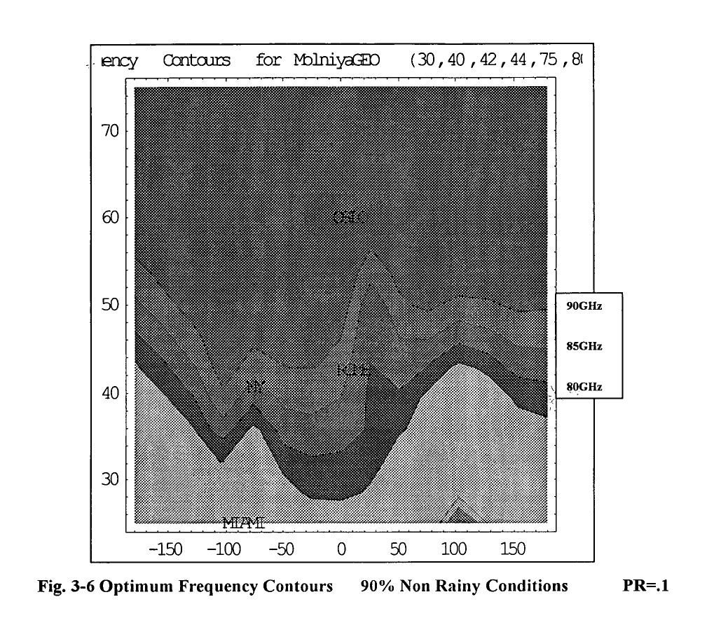

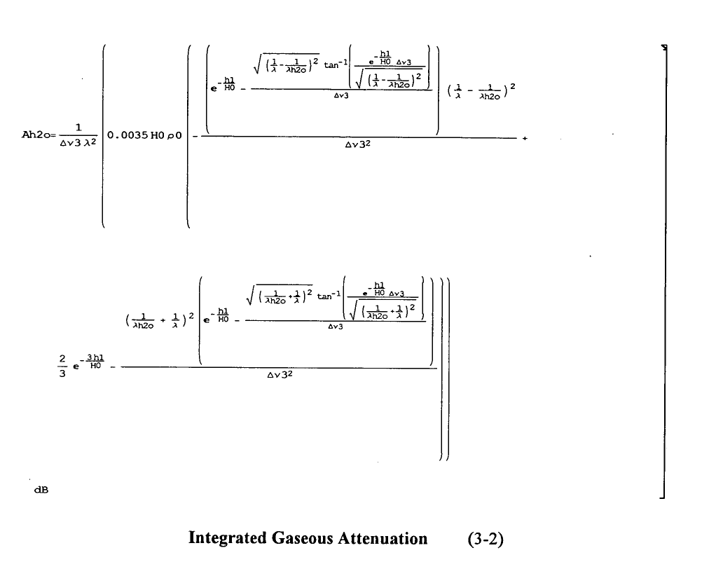

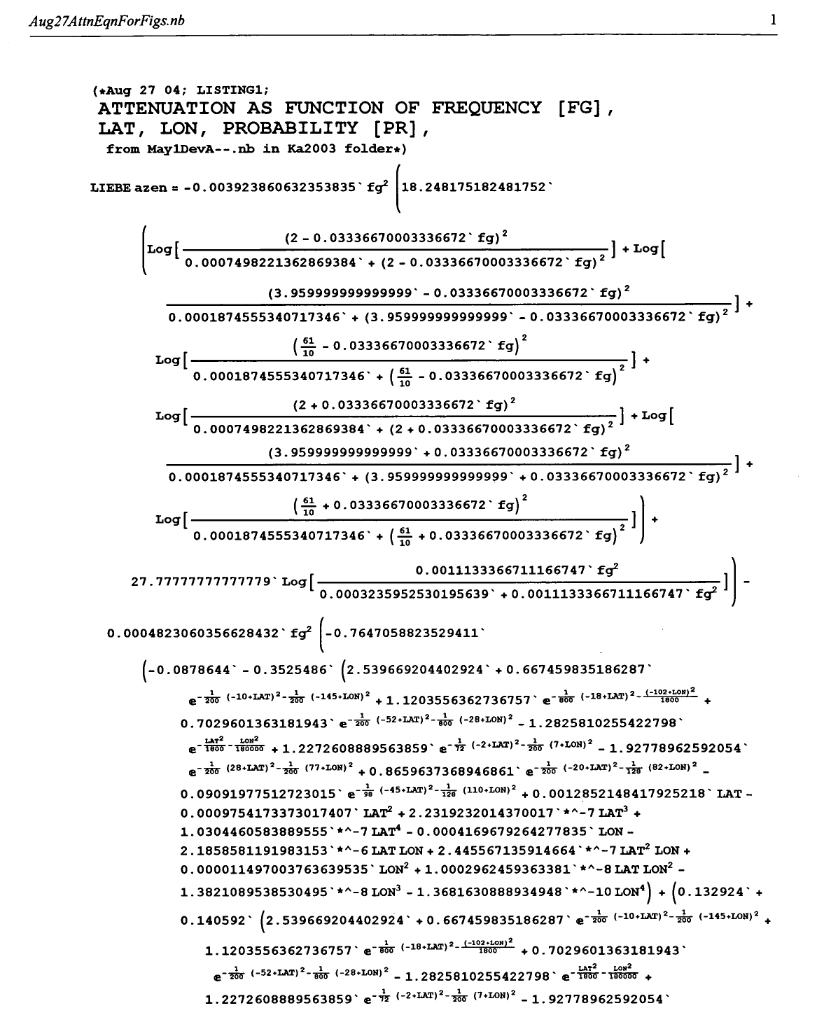

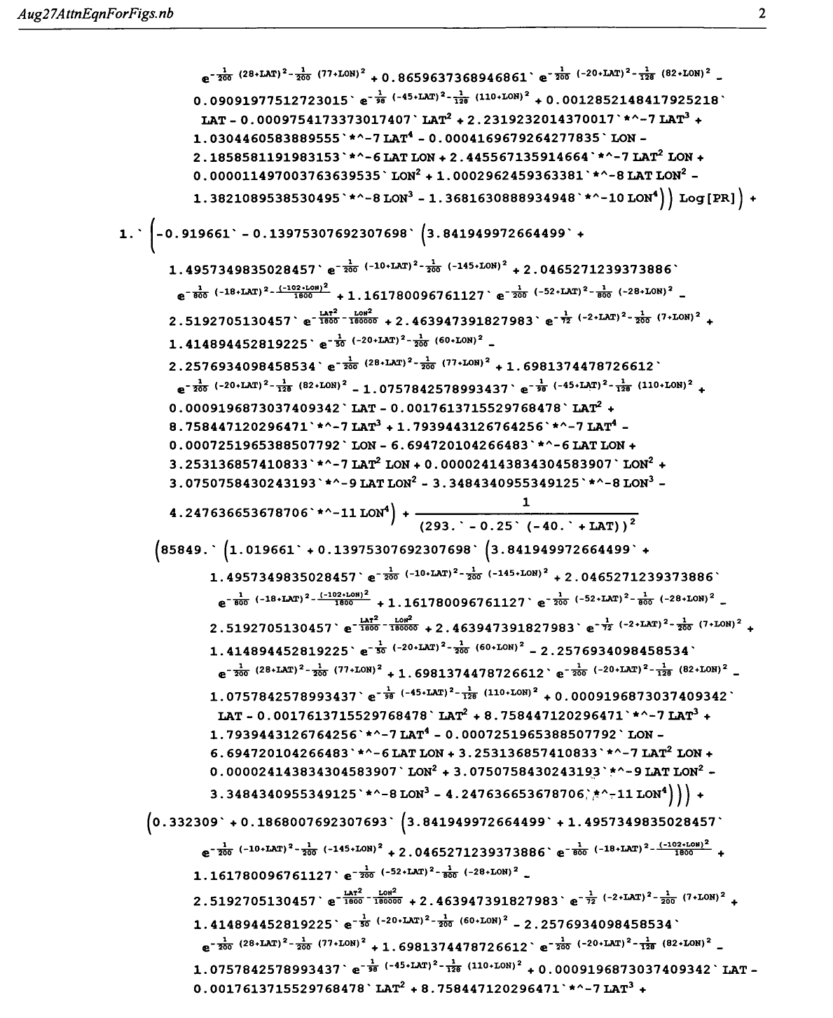

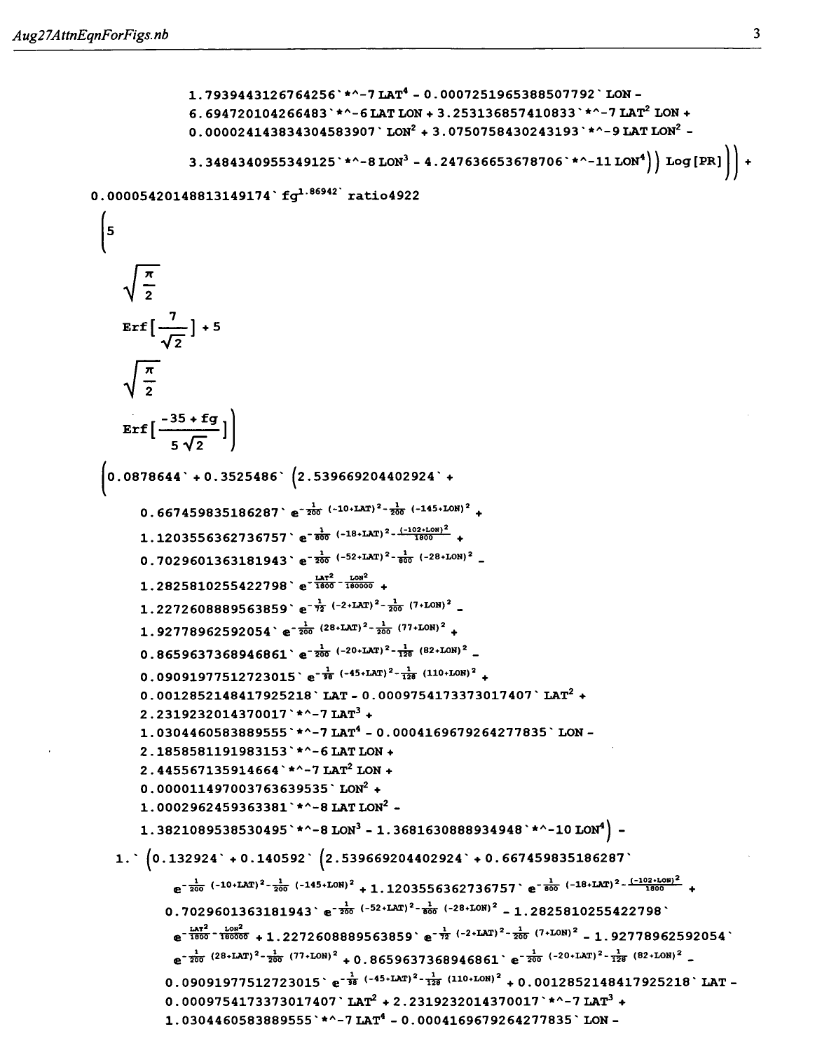

We saw in Cleveland [7] that attenuation could be described for a wide range of frequencies for 99% non rainy conditions. FIG. 3-1 shows examples for Guam, Rome, and Oslo. Net loss, formed from (Attenuation−Gain at Constant Aperture) could be described as FIG. 3-2.

FIG. 3-2 includes the typical frequency squared term for gain at constant aperture. We note that beamwidth would be reasonable even at 80 GHz for dish diameter as 0.2-0.5 meter. Attractive frequencies are indicated at 44 GHz and 79 GHz for Rome: Which one to choose? A global minimization would favor the 44 GHz solution for Rome, but we will see below that the less severe 90% non rainy attenuation found here will favor the higher frequencies.

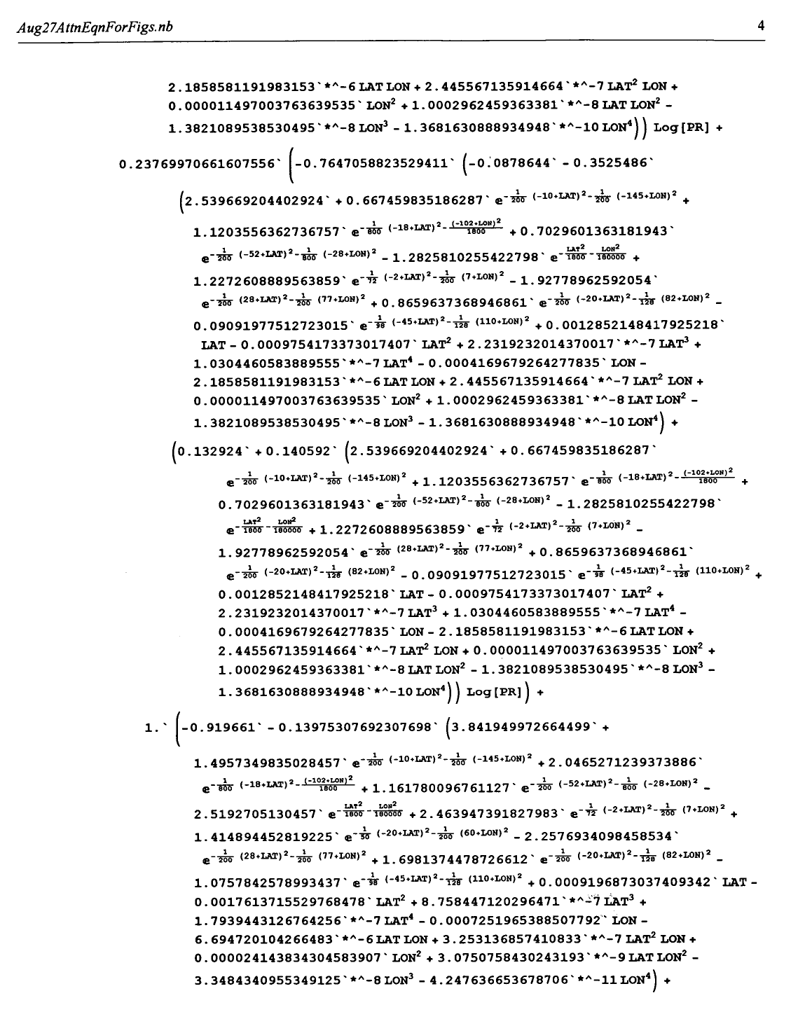

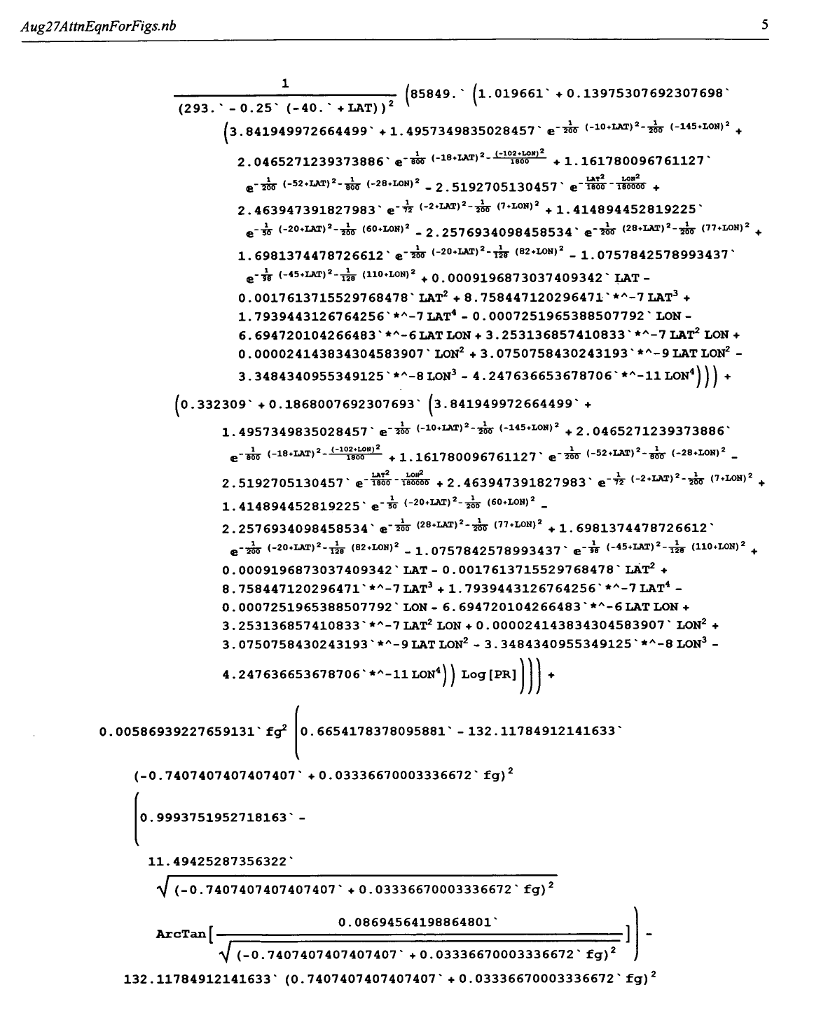

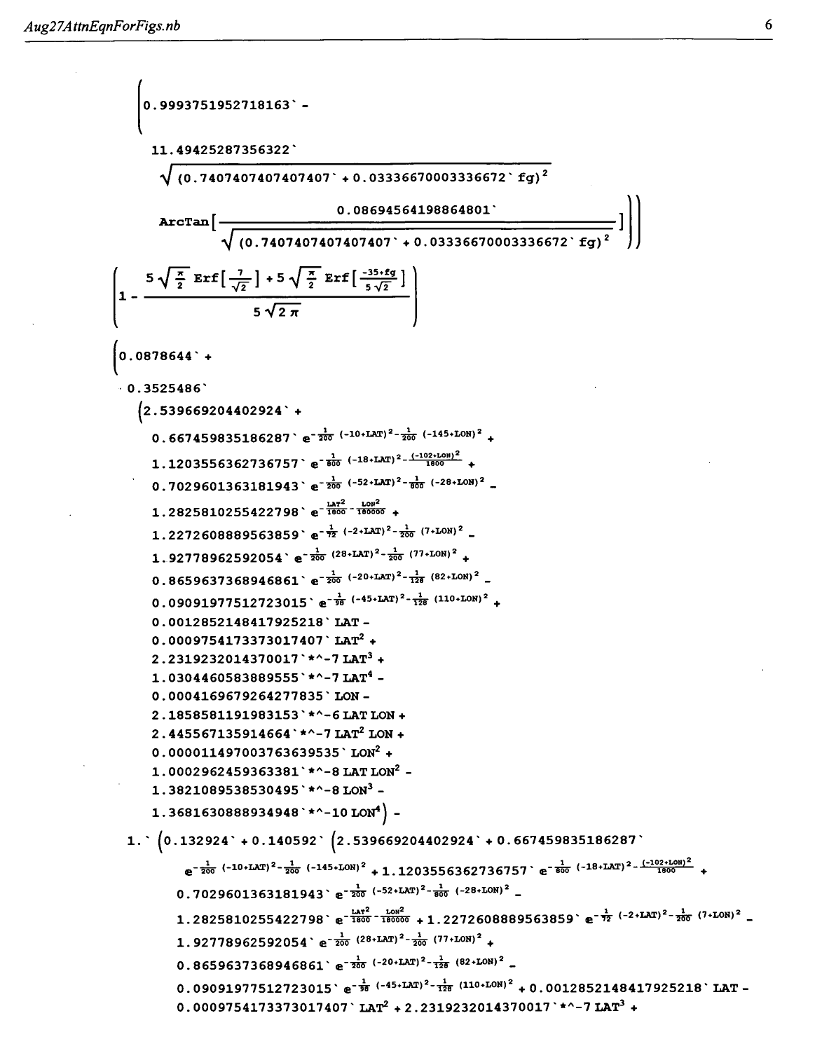

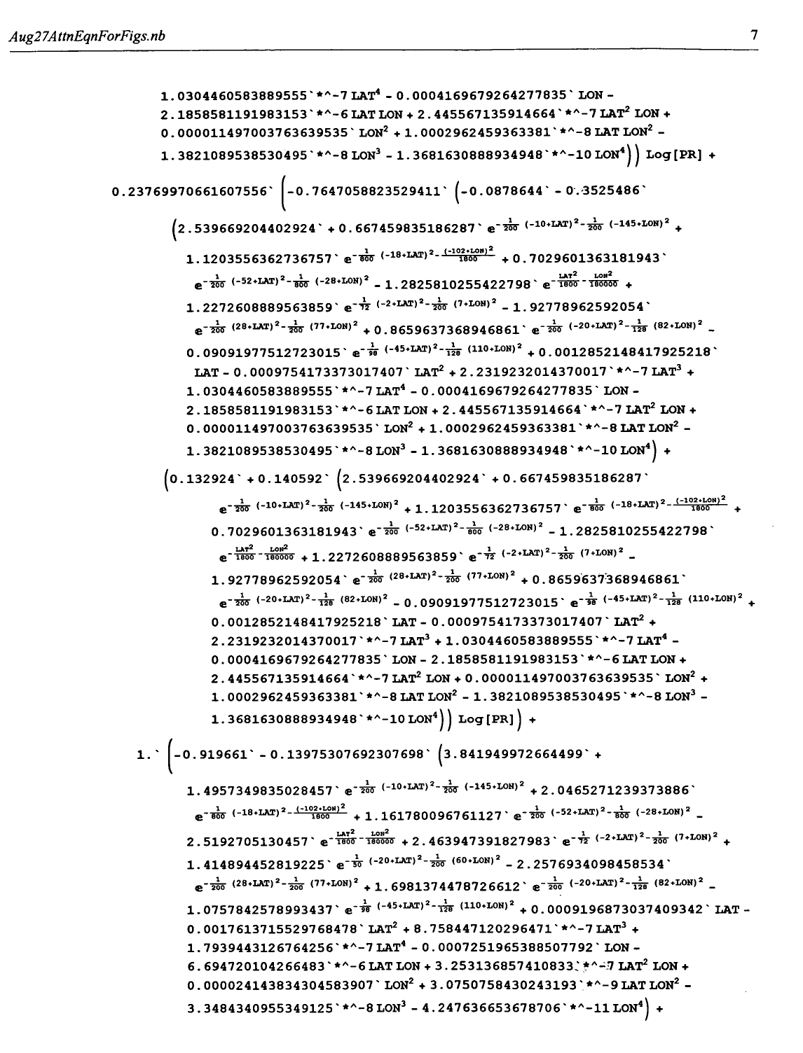

FIGS. 3-3 and 3-4 relieve the 99% non rainy attenuation to 90%, while retaining the other features of 3-1 and 3-2. Optimum frequency at Rome is indicated as 90 GHz. The trend of optimum frequencies can be found after a worldwide search, using each location for a decision as we did in FIG. 3-4. The result of the search, and subsequent curve fit to accommodate the sudden shifts past the 60 GHz oxygen line, can be seen as FIG. 3-5. Miami and Guam represent are shown as low frequencies, but most of the temperate zone north of 30N has attractive frequencies greater than 72 GHz.

NY City and Rome are indicated in FIG. 3-6 to have optimum frequencies near 85 GHz, as opposed to the closer indication as 90 GHz of FIG. 3-4.

Thoughts on the New, Lower Millimeter Wave Attenuation

We have extended the 99% non rainy attenuation global attenuation function to include less severe attenuation conditions, as a function of probability. This has raised the dimensionality of the zenith attenuation equation from four to five. The equations are long, and are included in a companion paper [10] and in the Figures.

The 90% non rainy condition was indicated here to allow 75-85 GHz frequencies to be used advantageously throughout much of the Temperate Zone. However, the 90% attenuation level would need help to bring it up to even modest availability requirements of VSAT stations. A Soviet cloud autocorrelation function [11] indicates this could be done with site separation on the order of tens of kilometers.

The integrated gaseous attenuation is listed with the Figures.

### Diversity Advantages for Nearby Sites

4. Background for Diversity

Rain attenuation has often discouraged satellite communication system designers from designing systems for the millimeter wave region. Rain attenuation can be severe for frequencies greater than 30 GHz, and designers have tried various methods to alleviate the rain attenuation. One key method has been the use of ground site diversity. Some diversity analysis indicates that ground site separation must be much greater than 10 km to achieve significant advantages for diversity. We develop analysis here to indicate that outstanding advantages can be found for distances often less than 10 km, and sometimes less than 5 km. We start with Furuhama's autocorrelation function for rainfall, then use a bivariate exponential probability density function (pdf) to derive a general attenuation exceedance probability for separated sites. The equation is then reverted to find a new equation for attenuation as a function of probability to meet the needs of communication engineers. Attractive frequencies well into the millimeter wave region will be indicated by the new results.

Some of the valuable early insights into the benefits of diversity centered on the concept of ‘Diversity Gain.’ Prof D. Hodge of Ohio State University developed explicit results (12) for Ku band systems, with helpful equations.

Clear advantages were shown for sites separated by over 10 km, and O.S.U went on to show advantages at the 30/20 GHz band.

Later, Morita and Higuti (13) recognized that it would be helpful to analyze the fundamental properties rain attenuation in order to generalize the diversity advantages to other distinct cases.

They used the powerful Lin (14) lognormal rain attenuation model to evaluate joint exceedance probability from two correlated sites. The transcendental result was so long that it offered intractable difficulty in reverting it for a general attenuation at two sites. A linear regression allowed helpful but limited insights into other frequencies and elevation angles.

We seek general results for a wide range of frequencies and elevation, and fundamental properties of rain cell sizes are required. Fortunately, Furuhama and Ihara (15) recognized that systematic and large scale efforts were needed to describe the effects of rain cell sizes.

5. Analysis

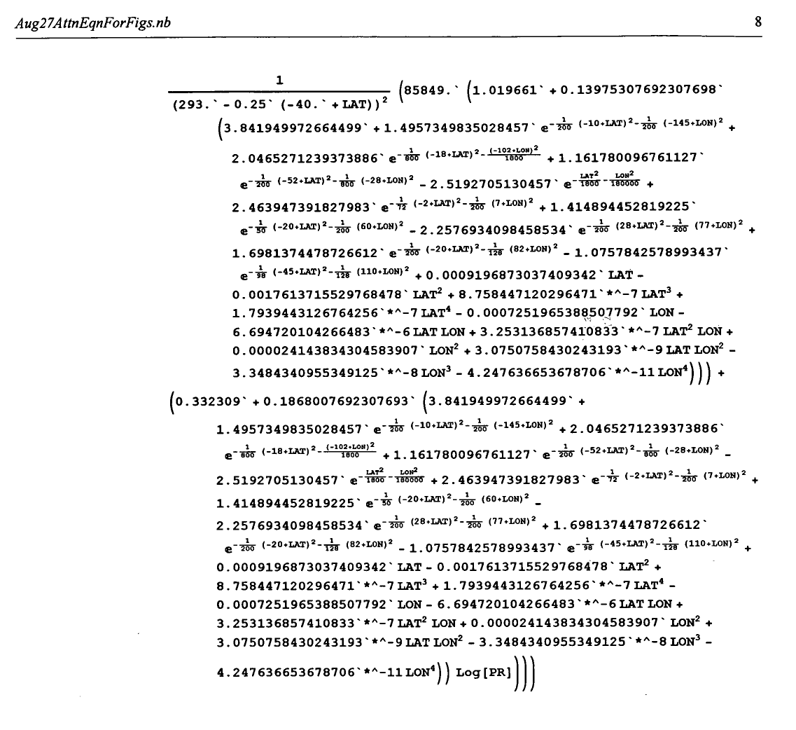

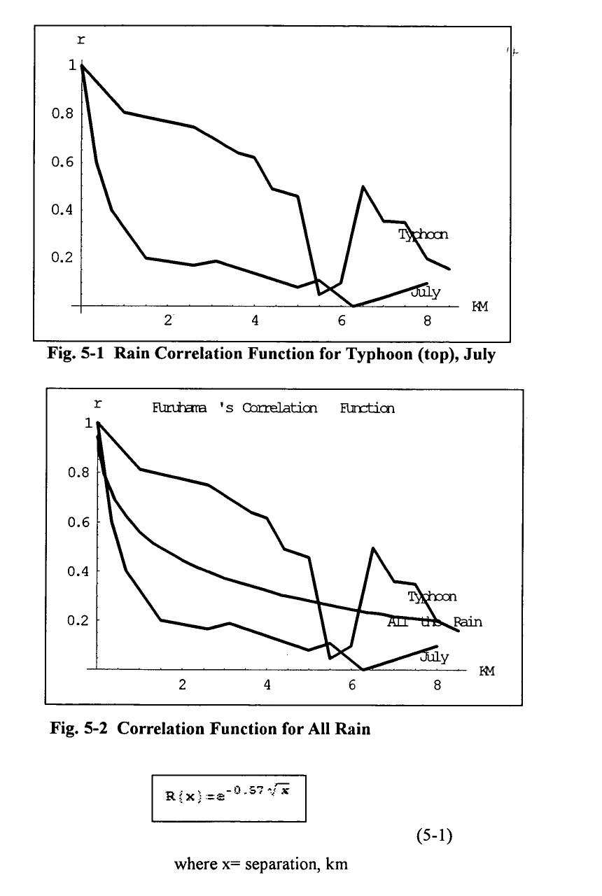

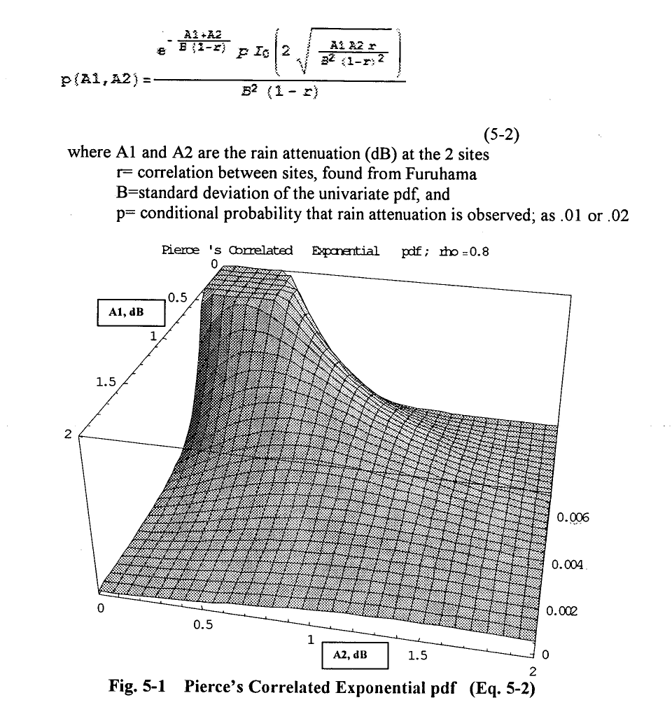

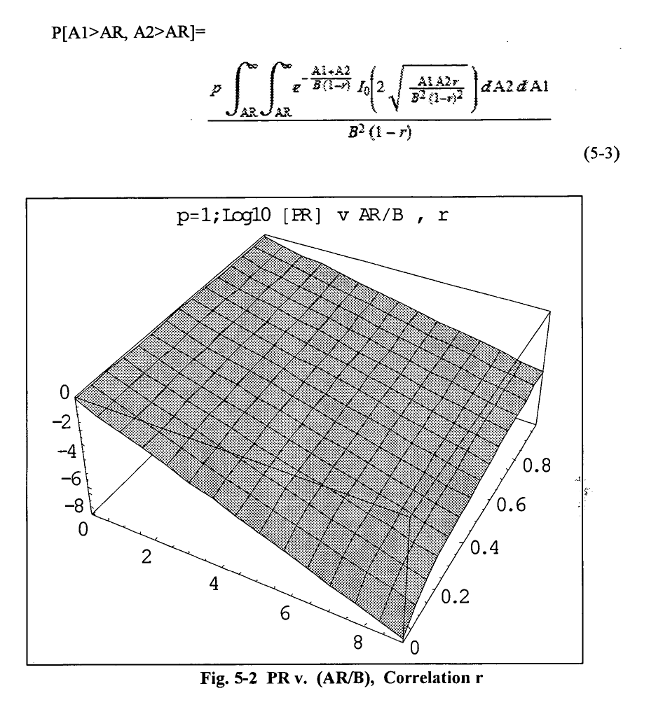

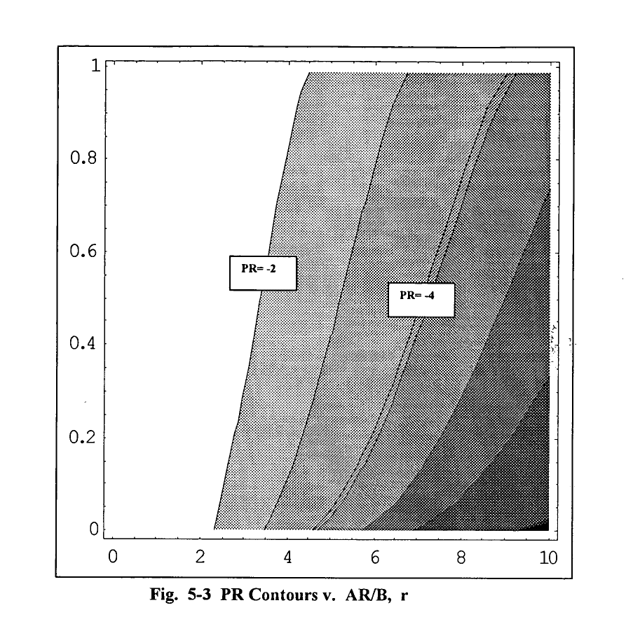

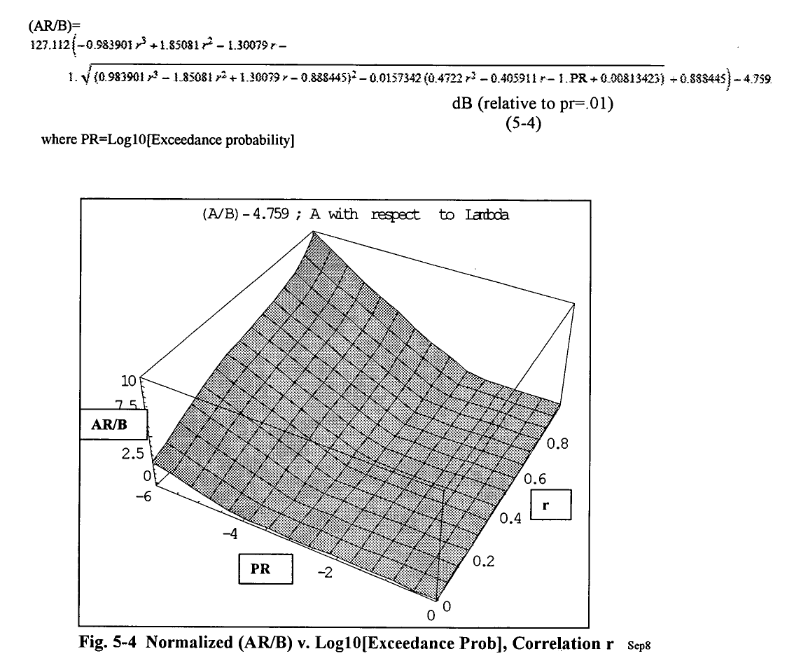

Furuhama and Ihara developed correlation functions to describe the rain rate relations between two separated ground stations. The correlation functions were seasonal, with large scale characteristics for hurricanes and much smaller sizes for most rains. FIG. 5-1 shows correlation function results for remarkably different seasons, as for a Typhoon season and for the month of July. FIG. 5-2 includes the results for all the rain.

Furuhama recognized that a correlation for all the rain (middle curve, FIG. 5-2) could be represented conveniently by the Equation 5-1.

Furuhama and Ihara's insight into the importance of the correlation function will next be seen with a description of Davies' bivariate exponential probability density function.

Furuhama's function can be used as a direct input into a correlated bivariate exponential pdf, and then to develop quantitative results for diversity advantages. We use the form of the correlated exponential pdf as Equation 5-2.

The double integral on the density function should be evaluated to find the joint probability of exceeding arbitrary attenuation levels. The probability of both sites having attenuation greater than AR (dB) may be functionally shown as Eq. 5-3.

The low values of the Furuhama correlation function (r) will be key to finding low probability of attenuation AR. System operators will recognize AR (dB) as the rain attenuation available with switched diversity, when they can choose the site with the least rain attenuation.

The integral has not yielded to attempts to integrate it exactly, and it turns out to be a very lengthy numerical integration. An upper limit is chosen as (10 B) rather than infinity. The exceedance probability (Eq. 5-3) is abbreviated as (pr) below.

The result of the double integration can be found as FIGS. 5-2 and 5-3. FIG. 5-2 shows exceedance probability (PR=Log 10(pr)) v. normalized (AR/B) and correlation coefficient r. Exceedance probability contours may also be shown as FIG. 5-3.

The bivariate function of FIG. 5-2 is defined for all possible weather events, even clear weather at both ground sites. Instead, the exponential density function should be defined for rain events in the 1% to 0.1% range: This is where the exponential pdf has the most relevance.

The communications engineer has a large problem remaining, even after the bivariate pdf has been solved. Eq. 5-3 expressed probability as a function of attenuation AR and standard deviation of the exponential function. This equation should be reverted for AR, as it was for the special condition of low correlation (r<0.2) and large separation distance (d>8 km) in 1983 (16). Eq. 5-3 can be reverted, with a close approximation, to give more general results suitable for nearby sites. Eq. 5-4 is a new result.

This new result can be plotted as FIG. 5-4. FIG. 5-4 assumes that interesting rain attenuation occurs only 1% of total time, so PR begins at Log 10[0.01]=−2. All rain attenuation inferred from FIG. 5-4 should then have the low 1% attenuation added to get the final estimate.

The result for switched diversity is related to attenuation in satellite communication systems in the next section.

6. Applications to Satellite Attenuation

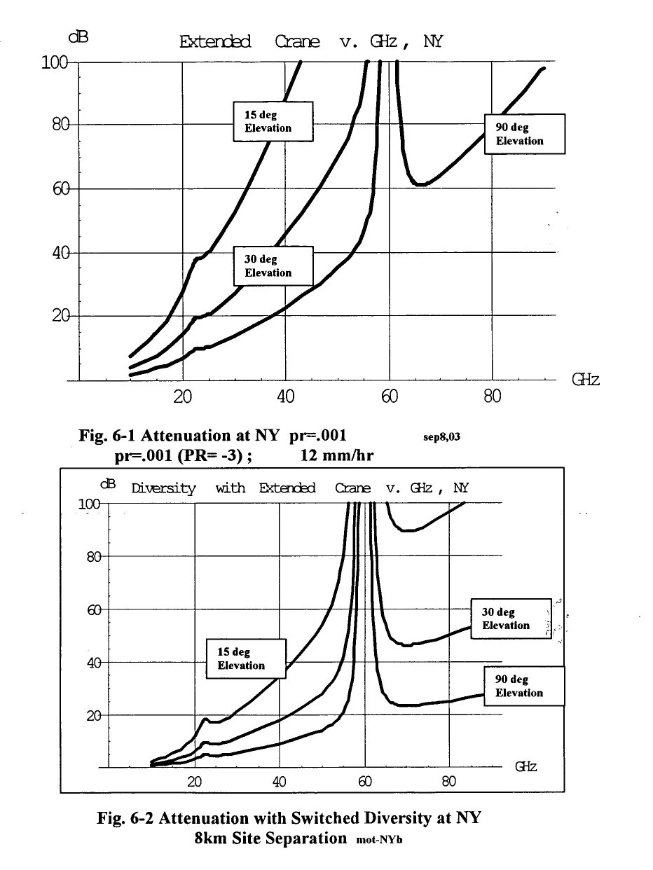

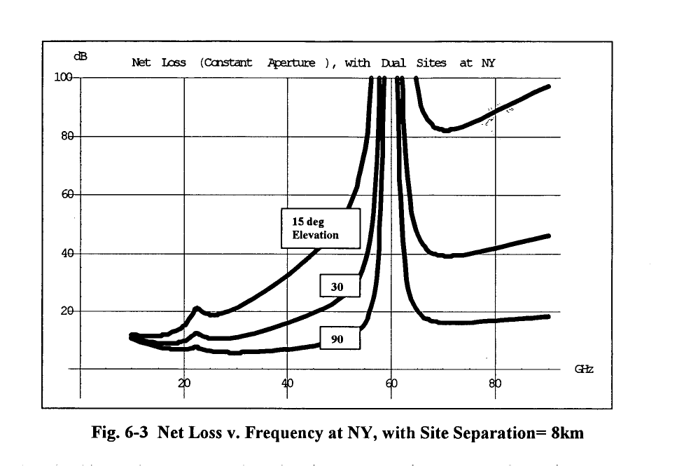

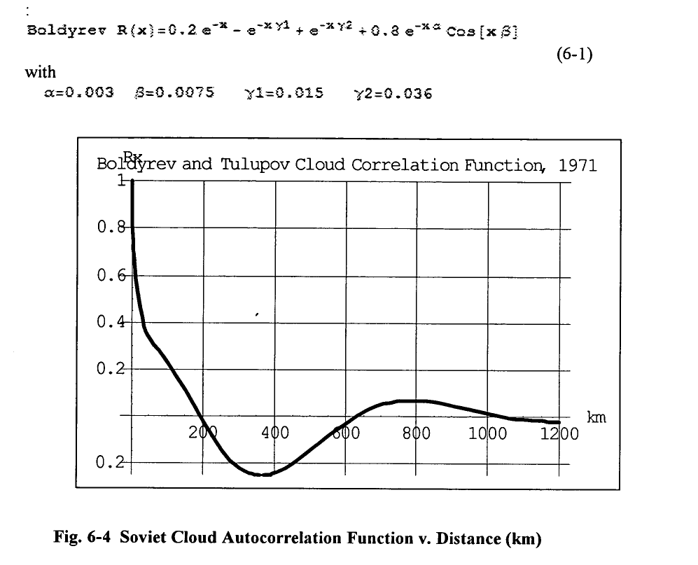

Exponential probability density functions are often observed for rain attenuation on satellite links, for probabilities ranging between 0.01 and 0.001. This range, for light to moderate rain attenuation, will be of primary interest for us because switched diversity will be a powerful weapon against higher attenuation. We extend a Crane rain model (17) to include sharply rising attenuation with frequency with the aid of G. T. Wrixon's Sun Tracker studies (18). The Sun Tracker studies showed attenuation (dB) tended to increase as f^{1.81} for the 16 to 90 GHz range. FIG. 6-1 shows single site attenuation at New York. FIG. 6-2 indicates the attenuation advantages of 8 km site diversity, especially for frequencies greater than 70 GHz. FIG. 6-3 shows net loss (loss−gain) for constant aperture antennas, using the benefits of 8 km site separation.

FIG. 6-3 indicates that 30-40 GHz links would be expected to do well at 99.9% availability for satellite passes near zenith. The higher satellite bands, as 70-80 GHz, would not be expected to do as well at this moderately rigorous availability. Lower availability, or wider site separation, or 8 dB penalty, would be indicated at 70-80 GHz.

75-98 GHz Satellite Links

Barbaliscia cogently observed that many satellite systems are quite worthwhile with only 95-99% availability. These systems with modest availability might be able to simply ignore rain for systems planning: However, they would still need to pay close attention to cloud cover. Fortunately, Soviet space studies paid close attention to cloud autocorrelation functions. Boldyrev and Tulupov derived interesting properties of cloud cover, deriving a function as Equation 6-1:

Eq. 6-1 may be shown as FIG. 6-4.

The function is interesting in several ways, including the drop to negative values at 200 km. This would lead to a separate discussion about surprisingly robust diversity studies for rain attenuation which occurred at 200-300 km. We cannot go into that here, however, and we direct our attention to the correlation at distances less than 40 km. A detailed look at FIG. 6-4 would reveal correlation as 0.4 at 32 km. A millimeter wave satellite system with single link availability as 90% would be expected to improve its availability to almost 97% with two sites separated by 32 km. Two sites separated by 200 km should expect 99% non rainy availability.

This kind of diversity is less expensive than it appears: Separate NASA sites at White Sands, N. Mex. normally serve as separate data links, but could be used to serve a single priority link in extremus.

Thoughts on Correlation Functions and Diversity

Furuhama's rain correlation function has received relatively little attention, perhaps because the relation to communication link availability was not obvious. We applied the correlation function to a bivariate exponential pdf, and we developed a new result for net attenuation for switched diversity, as shown by Eq. 5-4. Relatively nearby sites are indicated to allow frequencies much higher than 30 GHz to be considered for high elevation satellite systems of reasonably stringent availability (0.999). The lower availability requirements for VSAT systems would benefit from Boldyrev's cloud autocorrelation function. Frequencies in the 75-98 GHz region could be strongly considered for VSAT systems in large parts of the temperate region, including New York and Rome.

7. Site Diversity for Reliable Satellite Communication

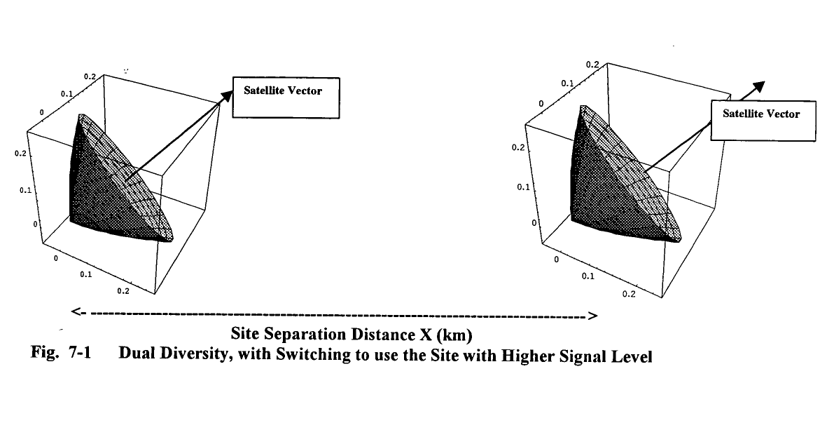

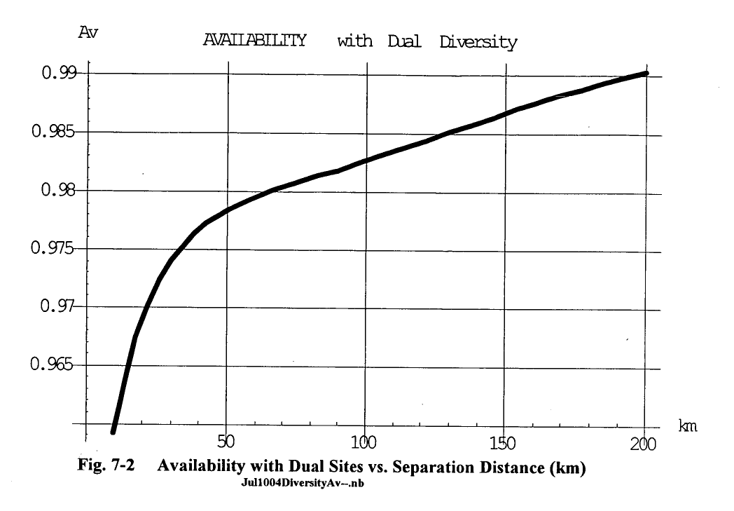

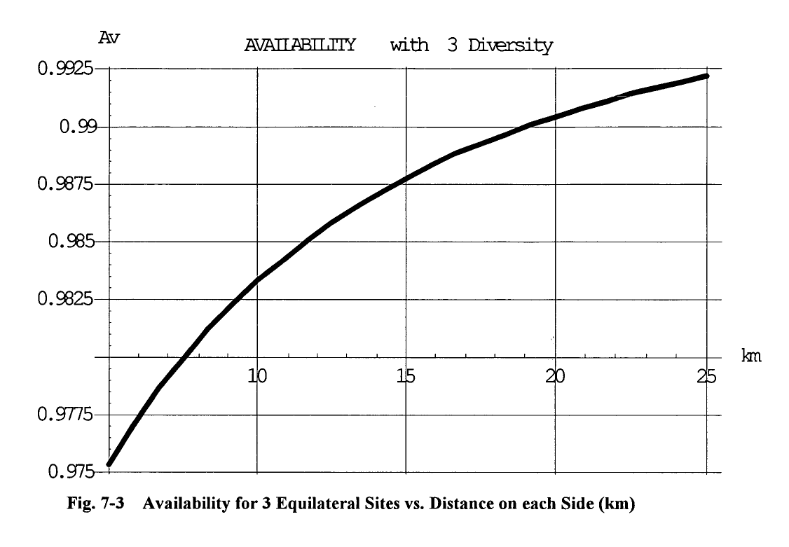

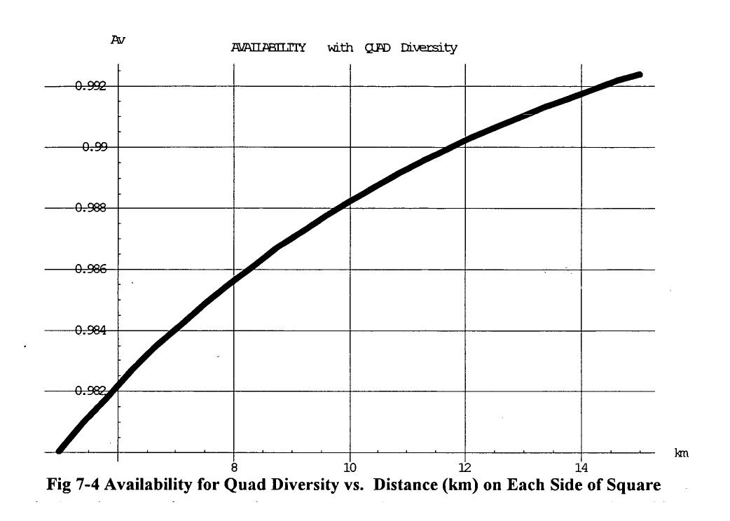

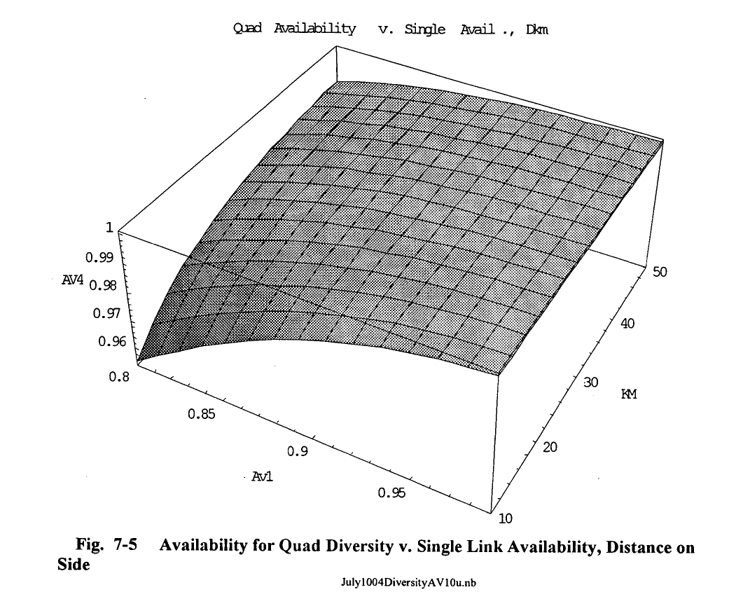

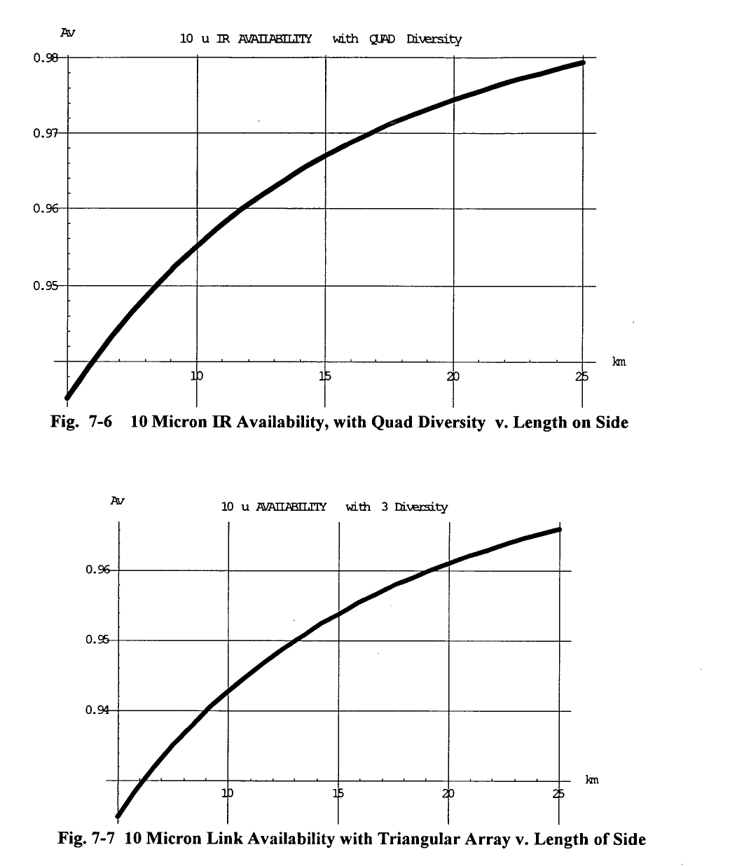

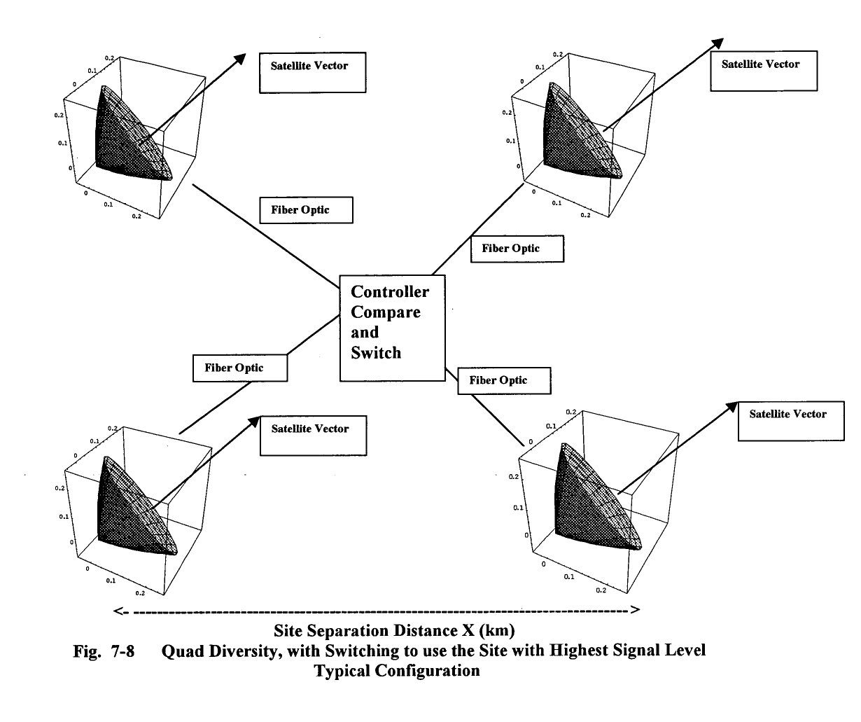

In this section, we show how the modest availability (90%) for a low attenuation 90 GHz satellite link can become a more acceptable availability with the aid of site diversity. The separated sites would use the Boldyrev and Tulupov cloud autocorrelation function to achieve much higher availability than a single site. Low attenuation may then be combined with much higher satellite frequencies to achieve much higher data rate from small terminals. FIG. 7-1 shows dual diversity at a satellite ground site.

We use the new results of site diversity (19) to find cloud attenuation as a function of correlation coefficient r. Net attenuation was found in (19), with a close approximation, to give more general results suitable for nearby sites. (Eq. 5-4, and FIG. 5-4).

Fortunately, Soviet space studies paid close attention to cloud autocorrelation functions. Boldyrev and Tulupov derived interesting properties of cloud cover, deriving a function as Eq 6-1 and it may be plotted as FIG. 6-4.

The modest attenuation (approximately 5 dB) shown at Rome and New York City at 90 GHz for 90% availability (FIG. 3-4, November 3 Ka Conference) can then be extended to more acceptable availability with the aid of a probability treatment of the Soviet autocorrelation function.

$$Av2 = 1 - {( 1 - av1 )}^{2 - 0.2 {ⅇ}^{- x} - {ⅇ}^{- 0.036 {x}_{+ {ⅇ}^{- 0.016} {x}_{- 0.8 {ⅇ}^{- 0.003 {x}_{Cos [ 0.0075 x ]}}}}}}$$

where av1=availability with 1 site=0.90 for typical 90 GHz satellite link av2=availability with 2 separated, switched diversity sites.

The higher availability may be shown as a function of distance in FIG. 7-2.

We see that modest single link availability at 90 GHz (90%) can be converted to 97% at approximately 22 km separation of dual switched sites, and 98% at 64 km. This would be in the more acceptable 95-99% availability region favored by VSATs.

Diversity with 3 Sites

The availability with 3 sites, spaced as an equilateral triangle with distance (X) on each side, shows even further improvement.

$$Av3 = 1 - {( 1 - av1 )}^{3 - 0.4 {ⅇ}^{- {x}_{- 2 {ⅇ}^{- 0.036 {x}_{- 1.6 {ⅇ}^{- 0.003 {x}_{Cos [ 0.0075 x ]}}}}}}}$$

The availability results can be seen as FIG. 7-3.

98% availability is indicated at less than 6 km, and 99% at 19 km.

Superior Availability with Quad Diversity

Four sites can be arranged as a square, with distance (X) on each side. The availability equation is:

$$Av4 = 1 - {( {( 1 - av1 )}^{2 - 0.2 {ⅇ}^{- x} - {ⅇ}^{- 0.038 x} + {ⅇ}^{- 0.015 x} - 0.8 {ⅇ}^{- 0.003 z} Cos ( 0.0076 x )} )}^{2 - 0.2 {ⅇ}^{- x} - {a}^{- 0.038 x} + {ⅇ}^{- 0.015 x} - 0.8 {a}^{- 0.003} \times Cos ( 0.0076 x )}$$

The superior availability with the four sites (with single site availability still as 0.90) can be seen as FIG. 7-4:

Note that 99% availability is achieved with only 12 km on each side of the square array.

Diversity for a Wide Variety of Single Link Availability

The 90 GHz results (above) have concentrated on a single link availability as 0.90. However, higher frequencies might necessarily concentrate on lower single link availability, and make up the difference with increased diversity, as quad diversity. FIG. 7-5 shows availability for Quad switched diversity as a function of single link availability (axis to the right) and length of each side of the square array. It shows availability approaching 95% even for a single link availability as 80%.

10 Micron Laser Links for Northeastern US, with 80% Single Link

The power of quad diversity may be applied to the patent filing (2) on laser links for the Northeastern US. With single link availability limited to 80% to keep the 10 micron attenuation to reasonable levels, a square array could be applied to bring total availability up to the standards of FIG. 7-6.

The availability for the 10 micron link is seen to approach 98% for a square array with 25 km sides. Availability would be expected to be more modest but still perhaps acceptable with a triangular array as FIG. 7-7.

Typical Configurations for Superior Data Rates Using the Method of the Invention

The method would typically use quad diversity for high availability, while retaining small overall array size. Each corner of the array would be connected by a fiber optic link to a controller, and the array would have the option of connections to the two nearest receivers. A typical square array configuration is shown as FIG. 7-8 (p. 54, Drawings). Signal strength would be compared at the controller, and the signal from the strongest source would be chosen to be the output signal.

Typical Configuration for Millimeter Wave (90 GHz) Receivers

The square array (FIG. 7-8) would have the length of the sides as approximately X=12 km to achieve 99% availability. This would allow the modest 5 dB attenuation of the single links to yield a typically useful availability.

Typical configuration for Infrared (3 to 10 Micron) Receivers

The square array would have the length of the sides as approximately X=25 km to achieve 98% availability. This would allow massive data rates from communication satellites, or deep space links. The method would be especially valuable for deep space links which have high data rates but require small transmitters.

This typical 25 km on a side would apply to important but somewhat difficult areas like New York City and Rome. The sides could be shortened and availability increased for more benign areas as the southwest U.S.

### SELECTED REFERENCES

1. Provisional Patent Filing 60/514,843 Filed Oct. 27, 2003
   Method to Extend Millimeter Wave Satellite Communication (75-98 GHz) to Wide Areas in the Temperate Zone Inventor Paul F. Christopher
2. U.S. application Ser. No. 09/986,057 Filed Nov. 7 2001
   Broadband Communication For Satellite-Ground or Air-Ground Links
   Inventor: Paul F. Christopher
3. U.S. application Ser. No. 10/079,411
   Filed: Feb. 22, 2002
   Title: A System and Method for Satellite Communications
   Inventors: John E. Draim, Paul F. Christopher
4. A. K. Kamal, P. Christopher, “Communication at Millimeter Wavelengths,” Proc. ICC, Denver, 1981.
5. F. Barbaliscia, M. Boumis, A. Martellucci, “World Wide Maps of Non Rainy Attenuation for Low-Margin Satcom Systems Operating in SHF/EHF Bands,” Ka Band Conference, September 1998.
6. Paul Christopher, “World Wide Millimeter Wave Attenuation Functions from Barbaliscia's 49/22 GHz Observations,” Ka Band Conference, Taormina Sicily, October 1999.
7. Paul Christopher, “Satellite Constellations for Ka Band Communication,” Ka Band Conference, Cleveland, Ohio, June 2000.
8. John E. Draim, Paul Christopher, “Reducing Extra-High Frequency Attenuation by Using COBRA Elliptical Orbit Systems,” AIAA Proceedings Paper AIAA-2002-1907, Montreal, June 2002.
9. F. Barbaliscia, M. Boumis, A. Martellucci, “Characterization of Atmospheric Attenuation in the Absence of Rain in Europe in SHF/EHF Bands for VSAT Satcom Systems Applications,” Ka Band Conference, Sorrento, Italy, September 1997.
10. Paul Christopher, “Millimeter Waves for Broadband Satellite Communication, 75-98 GHz; Extended Version with Program,” Leesburg, Va., September 2003.
11. Boldyrev and Tulupov, Cloud Correlation Function, COSPAR Space Research XI, Leningrad USSR 20-29 May 1970, Vol. 1 Akademie-Verlag Berlin, 1971.
12. D. B. Hodge, IEEE Trans. Antennas Propagation, AP-24,1976, p. 250.
13. K. Morita and I. Higuti, “Statistical Studies on Rain Attenuation and Site Diversity Effect on Earth-to-Satellite Links in Microwave and Millimeter Wavebands,” Trans. Of the IECE of Japan, Vol. E61, No. 6, pp. 425-432.
14. S. H. Lin, “Statistical Behavior of Rain Attenuation,”, Bell System Technical-Journal, Vol. 52, No. 4, pp. 557-581.
15. Y. Furuhama and T. Ihara “Propagation Characteristics of Millimeter Wave and Centimeter Waves of ETS-II - - - ,” URSI Commission F Symposium, Lennoxville, Quebec, Canada, 26-30 May 1980.
16. P. Christopher, “Rain Attenuation from Correlated Ground Sites,” Proc. International Communications Conference, Boston, June 1983.
17. R. K. Crane, “Prediction of Attenuation by Rain,” IEEE Trans. On Communications, Vol. COM-28, No. 9, September 1980.
18. G. T. Wrixon, “Measurements of Atmospheric Attenuation on an Earth-Space Path at 90 GHz using a Sun Tracker,” BSTJ, Vol. 50, No. 1, pp 103-114, January 1971.
19. P. Christopher, “Diversity Advantages for Nearby Sites, with Furuhama's Rain Correlation Function,” Ka Band Conference, Isle of Ischia, Italy, November 2003.

1. A satellite communication system comprising:
a terrestrial base station/array of base stations, and
a first satellite communicating with said base stations using 72-98 GHz carrier frequencies or 3 to 10 micron laser links (30 THz to 100 THz region).

2. The satellite communication system of claim 1, wherein attenuation is based on the frequency and probability of cloud water content representative of a region.

3. The satellite communication system of claim 2, wherein attenuation is defined by longitude and latitude (Eq. 3-3, Mathematica Listing).

4. The satellite communication system of claim 3, wherein the array size and characteristic distance between ground stations is determined by the cloud autocorrelation function and required communication link availability.

5. The satellite communication system of claim 3, wherein New York and Rome and large adjoining areas would successfully communicate at 90% availability with only single communication links to the satellite with wideband 75-98 GHz satellite communication using the method and the Mathematica listing of the Drawings. This is in marked contrast to the earlier filings (2,3) where New York and Rome were limited to approximately 44 GHz.

6. The satellite communication system of claim 4, wherein New York and Rome and large adjoining areas would successfully communicate with availability greater than 95% with wideband 75-98 GHz satellite communication using the method of Dual, Triple, or Quad Diversity and the array lengths described here. This is in marked contrast to the earlier filings (2,3) where New York and Rome were limited to approximately 44 GHz.

7. The satellite communication system of claim 4, wherein New York and Rome and large adjoining areas would successfully communicate with availability greater than 95% with Infrared Laser Communication Links (near 10 micron wavelength) using the method of Dual, Triple, or Quad Diversity.

8. The satellite communication system of claim 3, wherein New York and Rome could use highly inclined elliptic satellites, as Molniya satellites or other inclined satellites, for the 75-98 GHz communication, as the prior filings used (2,3).

9. The satellite communication system of claim 3, wherein New York and Rome could also easily use ordinary geosynchronous satellites for the 75-98 GHz millimeter wave communication, unlike the earlier filings (2,3).

10. The satellite communication system of claim 4, wherein New York and Rome and large adjoining areas would successfully communicate with 3-10 micron infrared laser links via satellite communication using the method. This is in marked contrast to the earlier filings (2) where the 10 micron links were limited to remote areas as Bangor Me., and had limited 80% availability. The method would use Quad Diversity, as a nearly square array of ground sites, to deliver high availability as Eq. 3 (above):
$$Av4 = 1 - ( {( 1 - av1 )}^{2 - 0.2 {ⅇ}^{- x} - {ⅇ}^{- 0.036 x} + {ⅇ}^{- 0.018} {x}_{- 0.8 {ⅇ}^{- 0.003 {x}_{{Cos ( 0.0076 x1 )}^{2 - 0.2 {ⅇ}^{- x} + {ⅇ}^{- 0.016 {x}_{- 0.003 {x}_{Cos [ 0.0076 x ]}}}}}}}}$$
where av1=single site availability=0.80 for 10 micron laser sites.
and x=typical array dimension (km).

11. The satellite communication system of claim 4, wherein the method would allow Deep Space communication to proceed at high data rates with small devices and relatively low cost communication systems. Quad diversity and Eq. 3 would be especially effective for Deep Space communication.

12. The satellite communication system of claim 4, wherein diversity switching would not be limited to maximum signal switched diversity, but could also use other common diversity methods, as Maximal Ratio combining.

13. The satellite communication system of claim 4, wherein the cloud correlation function could be found locally, and not confined to the cloud correlation function of Boldyrev and Tulupov.
